(19) United States
(12) Patent Application Publication
(10) Pub. No.: US 2002/0180727 A1
(43) Pub. Date: Dec. 5, 2002

(54) Shadow buffer control module method and software construct for adjusting per pixel raster images attributes to screen space and projector features for digital warp, intensity transforms, color matching, soft-edge blending, and filtering for multiple projectors and laser projectors

(76) Inventors: Ronald James Guckenberger, Longwood, FL (US); Francis James Kane JR., Winter Springs, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/207,443

(22) Filed: Jul. 26, 2002

Related U.S. Application Data
(63) Continuation-in-part of application No. 09/989,316, filed on Nov. 20, 2001.
(60) Provisional application No. 60/252,560, filed on Nov. 22, 2000.

(51) Int. Cl. G06T 1/00

(52) U.S. Cl. 345/418

(57) ABSTRACT

Computerized method that provides user control of multiple reusable parallel buffers that have utility in mapping and processing digital transformations to improve formation of composite images for single or multiple images. Pixel and sub-pixel memory maps (i.e., Shadow Buffers) of screen space and projector attributes (e.g., gamma, contrast, intensity, color, position, stretching, warping, soft-edge blending, etc.) are used to improve the final overall composite image. Composite imagery improvements include multiple projected images digitally soft-edge blended into seamless tiled image display; single or multiple projected images digitally warped into a seamless tiled image for curved screen displays; single or multiple projected images digitally warped for geometric correction; single or multiple images digitally corrected for defects in the projector or display device; single or multiple images digitally corrected for defects in the display screen(s); and single or multiple images digitally combined or subtracted for sensor fusion, synthetic visions, and augmented reality. Digital image manipulation and control means enable the use of low cost solutions such as digital projectors and achieve tiling of multiple low-cost visual channels coupled with low-cost high lumen LCD projectors to produce high-resolution, high-brightness projected displays suitable for military simulation and commercial applications within the image generation device and does not require additional custom hardware. Further, the parallel nature of the Shadow Buffer supports combinations for a plurality of applications. A digital video combiner is leveraged to obtain ultra high-resolution.

### SPECIFIC DATA RELATED TO THE INVENTION

This application is a continuation-in-part of U.S. non-provisional application Ser. No. 09/989,316, filed Nov. 20, 2001; and U.S. provisional application Serial No. 60/252,560, filed Nov. 22, 2000.

### GOVERNMENT RIGHTS CLAUSE

The United States Government has rights to this invention pursuant to Contract Number N61339-00-C00045 issued by the Training Systems Division of the Naval Air Warfare Center.

### BACKGROUND OF THE INVENTION

The present invention is generally related to computer image generation, and, more particularly, to a computerized method for user control and manipulation of composite imagery.

Image generators (IG) output real-time video, typically analog signals, to be displayed. Modification to these analog signals is required to improve the displayed image quality and support numerous applications (e.g., training simulation, picture-in-picture, superimposed image applications, etc.). This modification is typically performed with in-line dedicated hardware such as video mixers. The in-line hardware receives analog signals output from the IG; performs the desired alterations to these signals; and outputs modified video to a display or projector system for viewing. Providing the required video control necessitates the utilization of high-cost cathode-ray tube (CRT) based projectors. However, CRT based projectors do not possess the luminance quality desired. CRTs also degrade resulting in increased maintenance costs to support expensive replacement. Light valve-based projectors provide more luminance than CRTs, but are even more costly. These constrained hardware implementations are not only costly, but device dependent and very limited relative to user-control.

Digital projectors, such as liquid crystal displays (LCD) or micro-mirrors, could potentially provide high luminance at low cost for various applications namely, training simulation. They offer some control such as optical keystone correction, digital resizing, and reformatting. However, their applicability is inhibited due to limited control necessary to achieve required video results. For example, a training simulation application using a dome display configuration is comprised of multiple projectors that require warping of the projected image to correct for system distortion realized at the trainee's eye-point, to stretch images eliminating gaps, and to overlap between projected images. The control limitation also precludes the use of low-cost graphics boards for these types of applications.

In view of the foregoing issues, it would be desirable to provide digital image manipulation and control means enabling the use of low cost solutions such as digital projectors and achieve tiling of multiple low-cost visual channels coupled with low-cost high lumen LCD projectors to produce high-resolution, high-brightness projected displays suitable for military simulation and commercial applications.

### BRIEF SUMMARY OF THE INVENTION

Generally, the present invention fulfills the foregoing needs by providing in one aspect thereof a comprehensive computerized method that provides digital image manipulation and control means enabling the use of low cost solutions such as digital projectors and achieve tiling of multiple low-cost visual channels coupled with low-cost high lumen LCD projectors to produce high-resolution, high-brightness projected displays suitable for military simulation and commercial applications. The present invention further fulfills the control means that incorporates regionally controlled image warping to allow for distortion correction and edge matching; regionally controlled brightness to allow uniform brightness and edge matching; user-controlled gamma function; user-controlled pixel-based gain to allow for compensation of screen blemishes; and adjustable edge boundary brightness roll-off to allow blending of overlapped projector images. This method may be characterized as providing user control of multiple reusable parallel buffers that have utility in mapping digital transformations to improve formation of composite images for single displays or multiple projected images. Additional pixel and sub-pixel memory maps (i.e., Shadow Buffers) of screen space and projector attributes (e.g., gamma, contrast, intensity, color, position, stretching, warping, soft-edge blending, etc.) are used to improve the final overall composite image. Improved composite images comprise one or more of the following features:

Multiple projected images digitally soft-edge blended into seamless tiled image displays;

Single or multiple projected images digitally warped into a seamless tiled image for curved screen displays;

Single or multiple projected images digitally warped for geometric corrections for optical keystone and pincushion effects;

Single or multiple images digitally corrected for defects in the projector or monitor display device;

Single or multiple images digitally corrected for defects in the display screen(s);

Single or multiple images digitally combined or subtracted for sensor fusion, synthetic visions, and augmented reality;

The present invention is a software construct method in one aspect of the present invention that digitally controls the images within an IG or like device and does not require additional customized hardware.

### BRIEF DESCRIPTION OF THE DRAWINGS

The features and advantages of the present invention will become apparent from the following detailed description of the invention when read with the accompanying drawings in which:

FIG. 1 is an illustrative schematic block diagram representing major components of a simulation system.

FIG. 2 depicts an illustrative flow chart of exemplary processes that may occur utilizing an embodiment that leverages modifications supported by Shadow Buffers.

FIG. 3 depicts an exemplary memory-mapping scheme utilized by the Shadow Buffer Control Module 118.

FIG. 4 depicts exemplary Shadow Buffer Memory extensions.

FIG. 5 depicts an illustrative flow chart of exemplary processes that may occur utilizing an embodiment of a Shadow Buffer control panel.

FIG. 5 depicts an illustrative representation of tiled display overlap and edge effects for an array of tiled video channels along with a corrected composite blended scene generated using the Shadow Buffer invention disclosed.

FIG. 6 depicts an illustrative representation of tiled display overlap and edge effects user control panel for an array of tiled video channels.

FIG. 7 provides an illustration a projected scene that requires Shadow Buffer distortion correction along with a depiction of the Shadow Buffer distortion corrected scene.

FIG. 8 is an illustrative schematic block diagram representing major components of an exemplary configuration supporting color matching of the present invention.

FIG. 9 depicts an illustrative flow chart of exemplary processes that may occur utilizing an embodiment of a Shadow Buffer during set-up and initialization.

FIG. 10 depicts an illustrative flow chart of exemplary processes that may occur utilizing an embodiment of a Shadow Buffer during real-time processing.

FIG. 11 is an illustrative schematic block diagram representing major components of a digital video combiner configuration achieving ultra high resolution.

FIG. 12 is an illustrative schematic block diagram representing major components of a digital video combiner configuration example.

### DETAILED DESCRIPTION OF THE INVENTION

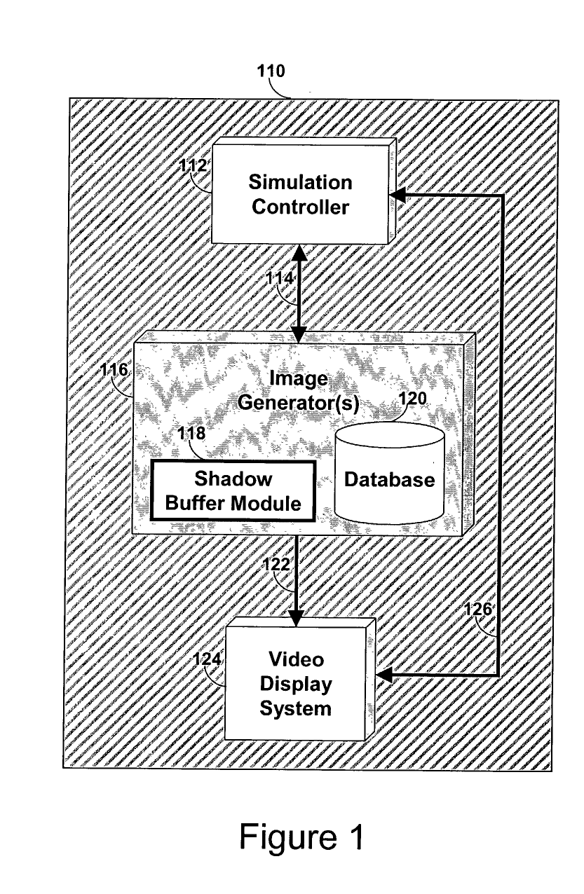

The present invention discloses a Shadow Buffer system and method to enhance blended composite imagery with a comprehensive user-control to adjust digitally generated images, improving the displayed video quality. The illustrative block diagram in FIG. 1 depicts an exemplary embodiment of a major training simulation system 110 with an embedded Shadow Buffer Module 118. The training simulation system 110 may be a reconfigurable system, modifiable to support multiple types of training simulation. The simulation controller 112 (i.e., also referred to by those skilled at the art as a simulation gateway or an IG gateway) is a computational system, the hub, for the training simulator in this exemplary embodiment. The computational system may be a specialized, robust computer system populated with specialized hardware to interface with all the required subsystems of the simulator configured as a high-end solution. Alternatively, the system can be a low-end computational system type such as, a desktop personal computer, a motherboard populated with appropriate computing devices, or any other commercially available computing apparatus capable of supporting the required functionality for a simple training simulator application. The simulation controller 112 communicates with simulator subsystems as required to support a particular training exercise and configuration. The simulation controller 112 communicates with IG(s) 116 via high-speed, wide band communication link(s) 114 (e.g., an Ethernet type communication bus link). The simulation controller 112 provides control data to the IG(s) 116 and receives hardwire sync data 126 from the video display system (VDS) 124. An IG 116 may be a single board computer, a desktop personal computer, a motherboard populated with appropriate computing devices, or any other commercially available computing apparatus capable of generating video images for a training simulator application. The training simulation system 110 may support a single IG or multiple IGs depending on the configuration required. It will be appreciated, that the exemplary configuration is just one example of a simulator that would allow the use of the disclosed invention. It should be further appreciated that numerous other configurations and applications could be used depending on the requirements of any given application.

The IG 116 outputs composite imagery to the VDS 124 via video cables 122. The IG 116 and video display system 124 are capable of processing imagery at a pixel (i.e., raster), and/or sub-pixel level. The VDS 124 may be comprised of any type of commercially available display solutions such as monitors (e.g., CRTs) or LCD projectors suitable for training simulation applications. Utilizing LCD projectors as components of the video display system 124 requires the use of associated flat panel or curved panel screens or domes. The video display system 124 can consist of either a single or an array of multiple display solutions, which are dependent on the training simulator system 110 training requirements and configuration capabilities of single or multiple IGs used. It will be appreciated that any other type of display solution could be leveraged for the video display system 124 dependent on the application being supported—by way of example, the display solutions could be curved head mounted displays (HMD).

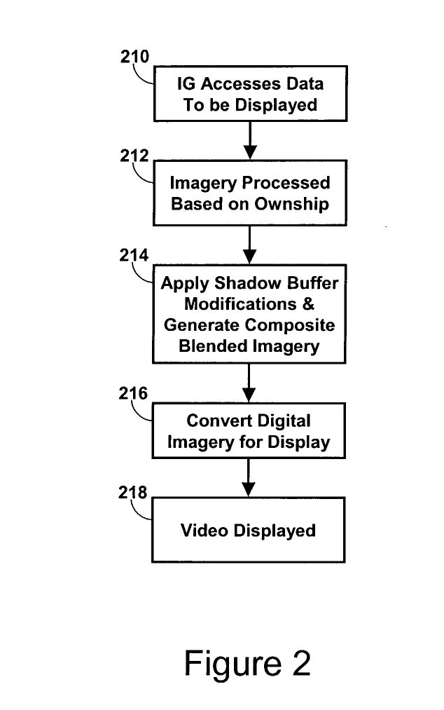

An IG receives ownship (e.g., the simulated position of the pilot's aircraft) and associated data from the simulation controller 112 for a particular location in the IG's visual database 120. The visual database 120 is comprised of a predefined three-dimensional structural data that is used by its associated IG 116 to create a composite image that will be displayed. For illustrative purposes, FIG. 2 depicts a high-level processing flow diagram where the IG accesses the specified data from the database 120, 210; processes digital imagery based on the ownship, eye-point, and associated data per the established simulator configuration 212; accesses the Shadow Buffers applying modifications to the digital image and form composite blended imagery 214; and converts composite imagery to analog video signals or digital packets for display 216. The analog video signals are outputted to the video display system 124 for presentation to the trainee (e.g., a pilot trainee for a flight simulator). Upon supporting multiple channels of video utilizing multiple projectors connected to a single IG, each projector displays a relative portion of the composite image associated with the position of the video display's geometry within the array of raster imagery.

In this exemplary embodiment, the Shadow Buffer Module 118 is a software construct embedded in the IG. The Shadow Buffer Module 118 is utilized to digitally control composite imagery without requiring addition custom hardware. It will be appreciated however, that hardware acceleration could be utilized. It will be further appreciated that since the Shadow Buffer is a software construct, it is not limited to a particular hardware configuration but can reside in a configuration that provides for appropriate access to the visual processing pipeline as illustrated in FIG. 2.

Subcomponents such as power supplies, interface cards, video accelerator cards, hard disks, and other commercially available subcomponents typically supporting a training simulator are not shown in the system diagram of FIG. 1.

Shadow Buffers

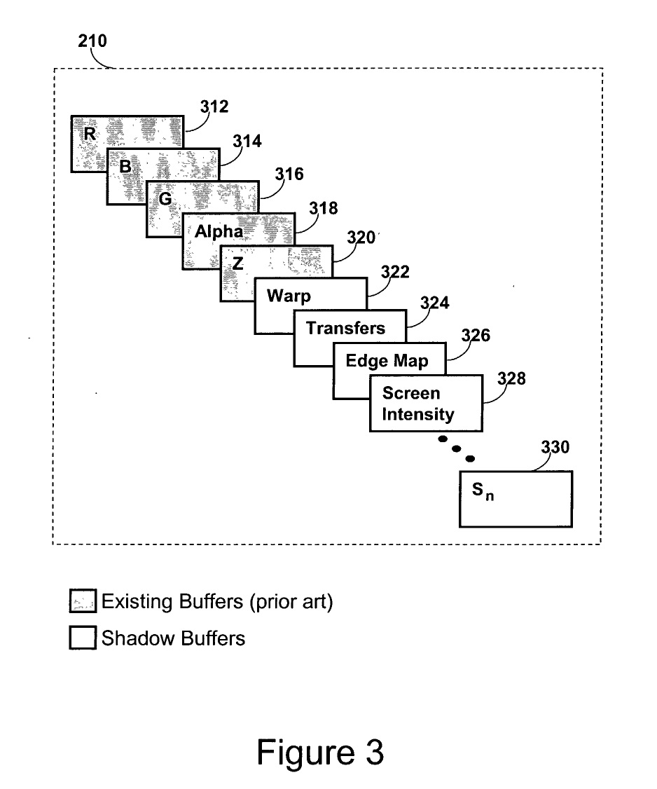

An IG 116 processes data from its associated visual database 120 to determine imagery values for each pixel. This rasterized video processing is performed for each frame of imagery. Processing is supported by memory allocation known as frame buffers. Frame buffers are used for temporary storage of the rasterized imagery data to be displayed. FIG. 3 provides an illustrative representation of memory buffers 310 in a parallel configuration. Red 310, blue 312, green 314, alpha 316, and z-depth 318 memory buffers are ubiquitous prior art memory buffers supporting this logic.

One aspect of the present invention characterizes the Shadow Buffer method as control of multiple reusable parallel memory buffers that support additional features and capabilities in the visual pipeline. Shadow Buffers are the regional, pixel, and sub-pixel memory maps utilized to improve the final overall composite imagery. Shadow Buffers leverage reusable parallel buffers to provide the capability of mapping digital transformations required to control screen space and projector attributes (e.g., gamma, contrast, intensity, color, position, stretching, warping, soft-edge blending, etc.). For example, one Shadow Buffer may contain screen space per pixel modifications needed to blend two projected visual channels into a seamless mesh, while another Shadow Buffer may support projector space attributes applying per pixel transforms to correct for dynamic range limitations of a particular projector.

In an exemplary embodiment, the user-controlled Shadow Buffers support digital warp 320, transfer 322, edge map 324, and screen intensity 326 buffers for single or multiple projected images. These Shadow Buffers enable a plurality of capabilities such as image transformations utilizing intensity, gamma, color, or on/off Shadow Buffer pixel (or sub-pixel) controls. Shadow Buffers enable similar or dissimilar (i.e., in source location) accumulation of sub-pixel or pixel source data into a cumulative image pixel. For example, source sub-pixels summed for a destination pixel on a dome-curved surface are normally from the same general source location. Likewise, the capability is provided to perform spatial transforms for geometric corrections (e.g., keystone and pincushion) that have source pixels from the same proximity (i.e., line position). Sub-pixels or pixels for different sensor images being blended have different memory source locations.

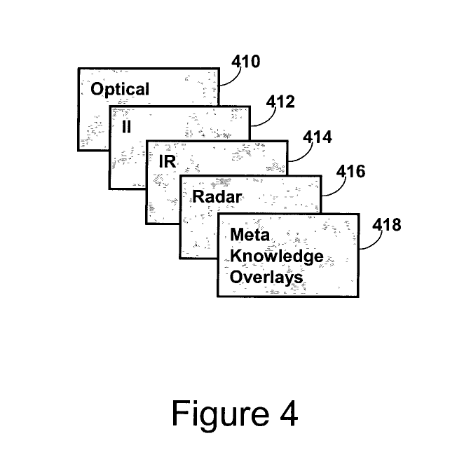

In another aspect of the present invention, the Shadow Buffers' parallel architecture is scalable. The representation in FIG. 3 illustrates the nth quantity 328 of Shadow Buffers. These additional Shadow Buffers may be employed to support other functions. A plurality of transformations may be applied to source data before it is output as final imagery. Multiple Shadow Buffers can be utilized to blend multiple images for such applications as sensor fusion, synthetic vision, and augmented reality. FIG. 4 depicts exemplary Shadow Buffer Memory Space concepts applied to Sensor Fusion, Overlays, and Synthetic Vision content namely an Optical Sensor 410, Image Intensification (II) 412, Infrared (IR) 414, Radar 416, and Meta Knowledge Overlays 418.

These exemplary extensions of Shadow Buffer utilization illustrate how different inputs may be digitally blended into the same buffer prior to being displayed. Blending real-world visual and sensor images with synthetic vision images calculated from photo-realistic geo-specific images may be accomplished. For example, map and digital terrain images may be blended with separate intensity controls for each image. Similarly, IR images and camera images of the same region may be blended. It is important to note that blending of a plurality of image types does not require the same resolution of image (i.e., source) data. Lower resolution image data may be “digitally zoomed” to the highest sensor's resolution in order to correlate and blend the resulting imagery. Blended images may possess additional graphics data incorporated by the Shadow Buffers that add for example, graphic overlays, cues, and warning zones to the actual displayed image for augmented reality effects.

In another aspect of the present invention, Shadow Buffers may augment an electro-optical Pod operation of a Predator Unmanned Aerial Vehicle (UAV) where actual camera or sensor imagery is superimposed with the synthetic vision view calculated by an electro-optical Pod simulation. Currently, UAVs utilize small field-of-view (FOV) sensors that have been scanned over a terrain. No automated method exists to track what has been scanned for a given target area of interest. The Shadow Buffer is capable of highlighting (i.e., with a semi-transparent color change), any pixel in the corresponding photo-realistic geo-specific images that have already been scanned. This enables a unique new application that aids sensor operators in the guidance of terrain scanning. Additionally, multi-channels of the synthetic vision view may be utilized to surround the actual worldview in order to provide a greater FOV. This yields an improvement in situational awareness. Additional augmented reality features that leverage Shadow Buffer imagery blending are comprised of applications for wire-frame or semi-transparent threat domes, target arrows, waypoint markers, and highway in the sky cues.

In yet another aspect of the present invention, Shadow Buffers may leverage spatial transforms between different sensor platforms providing digital warping, zooming, and perspective correction of a plurality of images from various platforms types. For example, real-time satellite imagery may be blended with imagery from a UAV; and the higher resolution UAV image inserted into the satellite image for the Command and Control view. The UAV ground operators may then be cued to other points of interest by the relative placement of this image insertion in the larger context of satellite imagery analogous to picture-in-a-picture functionality. It will be appreciated that additional Shadow Buffers could be leveraged to implement numerous other capabilities such as occulting processing, priority processing, enriched animation, effects processing, additional sensor processing, etc. as will be evident to those skilled at the art.

Soft-Edge Blending and Intensity Control

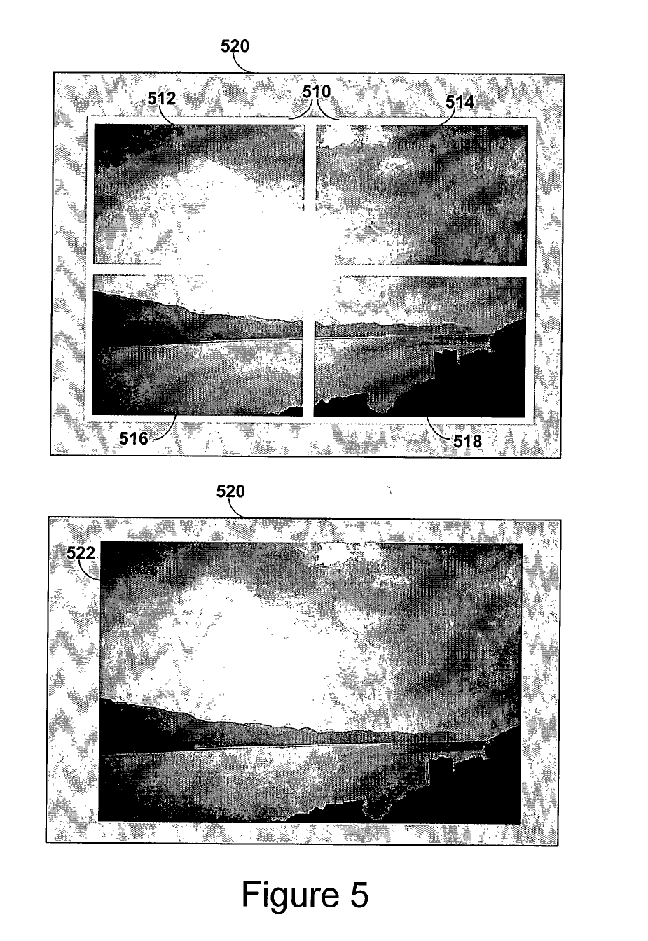

LCD projectors typically possess a small bright band of pixels along their outer edge 510 as illustrated in FIG. 5 where an array of tiled projected scenes is produced from four associated projectors and the scene is projected onto a screen 520. The top left projector scene 512, the right projector scene 514, bottom left projector scene 516, and bottom right projector scene 518 are to be blended (i.e., visually co-joined) as one contiguous composite scene 522. The three to four pixels wide bands 510 (i.e., from the actual edge pixel) may be the results of a defect associated with reflected light or edge effects resulting from light interacting with a LCD panel's interior to the projector. One aspect of the invention provides Shadow Buffer Soft-Edge Blending Brightness (Intensity) that permits computerized user-control of dimming or brightening bands of pixels located at the edge of a displayed image 510 (i.e. scene or a visual display channel of a composite scene) resulting in a vast improvement of the tiling of the projected scene into seamless high-resolution composite images 522.

For edge blending in an exemplary embodiment, a user controls a sequence of visible gradients to be blended within dynamic range boundaries of selected digital displays, which includes control for each of the four edges being adjusted via a graphical user interface (GUI) with three user controls. One control (e.g., a user controlled digital slider associated with a displayed numeric value) permits the user to indicate the quantity of edge pixels that will be affected by the other two user settings. The user selects the maximum intensity change for the affected pixels with one setting. The user then selects and indicates the change gradient from the first affected pixel in the selected band to the actual pixel for that row with the other setting. Upon assuming a left or right edge is used, a top or bottom pixel will require the gradient to be spread along each column. Blending functions may employ logarithmic, inverse log, sinusoidal, and linear computations. Alterations include but are not limited to, addition, subtraction, shifting, masking of bits or colors, scaling, accumulation, and logical and bit-wise operations. Masking alterations can simultaneously mask each color channel by different schemes related to the color bit methodology utilized. The alterations can be at the sub-pixel, pixel, region, and entire image levels. These computations are applied to a per pixel space memory location (e.g., intensity Shadow Buffer 328). The intensity change for the each computed image pixel will be applied as part of the blended imagery processing. Blending occurs as each image pixel is “read out” of the associated Screen Intensity Shadow Buffer 328. The pixel value in this buffer is used to alter the image pixel value before output. Screen space pixels modify the output of the calculated image pixels to reduce intensity so as to eliminate the bright band. This yields image improvements overcoming nuisances of display devices. Once the composite imagery is determined, this per pixel result is output from the IG.

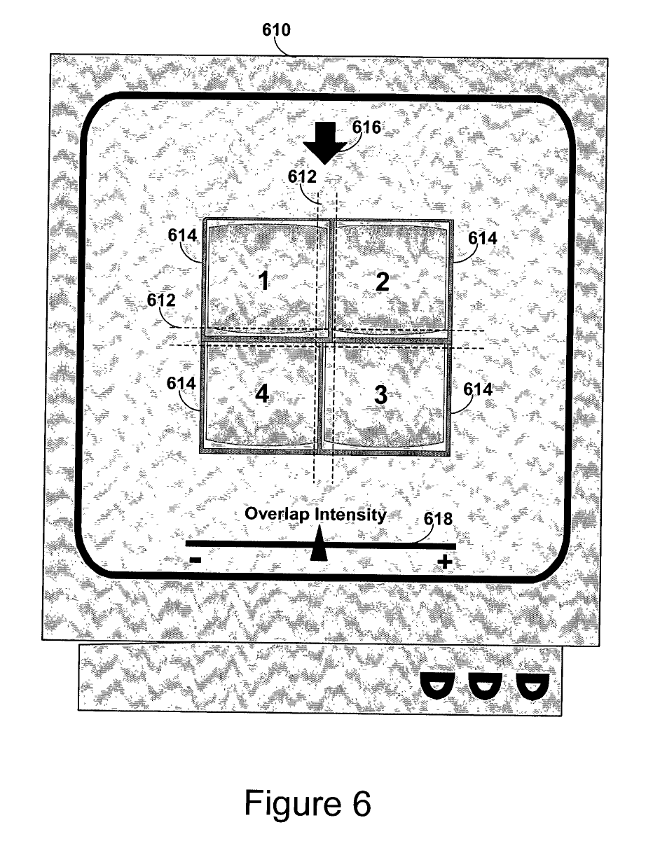

By way of example, consider a video display system 124 (FIG. 1) that is comprised of the array of projected scenes as depicted in FIG. 5 where video overlap and edge blending of the four video channels are required to produce the desired scene 522. In this exemplary embodiment, the user is provided with a computerized control enabling desired adjustments. These user controls may be implemented via a GUI. FIG. 6 depicts an illustration of the user's computerized control monitor 610 displaying the projector configuration representation. The video overlap, relative scene location (i.e., screen area where a channel of a composite scene is located) is controlled by the relative location of the associated visual channel graphical representation 614. The user may select (e.g., drag) the projector display representation 614 with a mouse type device and position it to a desired relative position. Then, the user specifies the amount of desired overlap for each of the common edges (i.e., edges shared with another projector), one edge at a time. This may be accomplished by using an indicator such as the arrow 616 to specify which edge is being affected. Finally, the user specifies the intensity of the pixels in the overlap regions 612. This may be accomplished utilizing a graphical slider scale 618 where positioning the slider arrow towards the right indicates more intensity control of the affected pixels conversely; positioning the slider arrow towards the left selects less intensity. Thus, the four-overlap region 612 (i.e., indicated by dotted lines) is defined in terms of the Shadow Buffer pixels and adjusted to compensate for the four displays 614 by overlapping intensity on a per pixel basis. Edge blending between adjacent projected displays on a per pixel basis is supported for side-by-side and vertical stack configurations. This per pixel control is important when tiled configurations produce a four-projector overlap region as seen in the tiled configuration of FIG. 5.

Mask Control, Digital Warp, and Distortion Correction

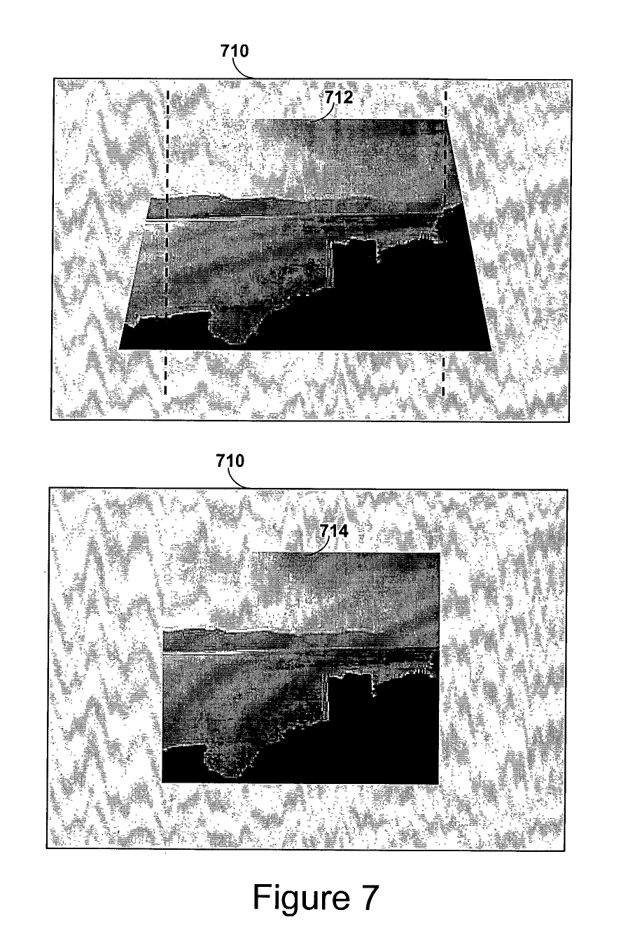

Another aspect of the disclosed invention relates to mask control, digital warping, and distortion correction. The mask control capability enables the user to conceal undesirable projector image characteristics, screen defects, and blemishes on a per pixel basis. This is accomplished in a manner similar to the Intensity Shadow Buffer solution described earlier. For example, a dome display with peeling reflective surface can have the intensity for that particular defect region increased or shifted to minimize the defect visually. Improvements are also made for projector keystone and pincushion effects by masking and shifting pixels spatially and in intensity. For example, the keystone effect 712 as shown in FIG. 7 where the top of the projected image is smaller than the bottom of the screen. The image would be masked (i.e. computed) to not draw the bottom pixels that are to the outside left and right areas (e.g., of the line defined by the projected top raster line). This mask restores straight left and right edges to the projected flat image on the screen 710 (e.g., curvilinear versions are also possible).

Corrected projected edges may require some pixels be projected at a percentage of their calculated value to smooth edge transition between discrete pixel locations. The effected bottom raster lines themselves must be spatially corrected to compensate for the masked pixels. If the masking removed 20 projected pixels from the bottom raster line that was originally 2000 pixels wide then the remaining 1980 pixels will be computed by calculating the percentage contribution of the source 2000 pixels to their 1980 destination pixels. This is pre-calculated once from the destination pixels backwards to develop a per source pixel contribution to each destination pixel. In this case, processing may be accomplished at a higher resolution than the actual projected image (e.g., displayed at a lower resolution than processed), which results in an improved image quality. This type of resolution processing may be accomplished to a level to reduce the need for anti-aliasing. Further leveraging this aspect, a VDS may be configured with additional projectors processing high-resolution imagery but outputting a composite image of a lower resolution yielding an even greater improvement in the resultant image quality.

Digitally warping of imagery consists of accumulating multiple sub-pixel elements in a Shadow Buffer for each warped destination pixel. For a given keystone correction or dome curved screen warp, the corresponding Shadow Buffer is defined from the calculated destination pixels backwards to select the source sub-pixels and their contribution to each destination pixel. The digital image frame buffer and associated Digital Warp Shadow Buffer are both larger than the actual display space. Shadow Buffer sub-pixel values are calculated as the contribution each associated image pixel makes to the final destination pixel. Again, this over-calculation of Shadow Buffer and associated image sub-pixels improves both image quality (i.e. increases resolution) and accuracy of the final warped image pixel representation on curved surface(s). For example consider, an improperly constructed back-projected screen becomes bowed in the middle due to its own weight. The bow is located in a vertical screen. The bow produces a pincushion effect causing black-area separation in a 4-tile scene. Geometry correction can compensate for this screen defect by masking the pincushion bulge and spatially correcting the center section for the masked pixels.

A variation of the Shadow Buffer Digital Warp method takes advantage of current graphic board hardware features. This variation uses the Shadow Buffer as a 3D polygon representation of a curved surface to be projected. The calculated 2D image pixels can be warped onto the surface by normal graphics tri-linear mip-map processing. This method does not have the accuracy of the sub-pixel method and may require additional frame time delays.

Color Matching with Digital Cameras

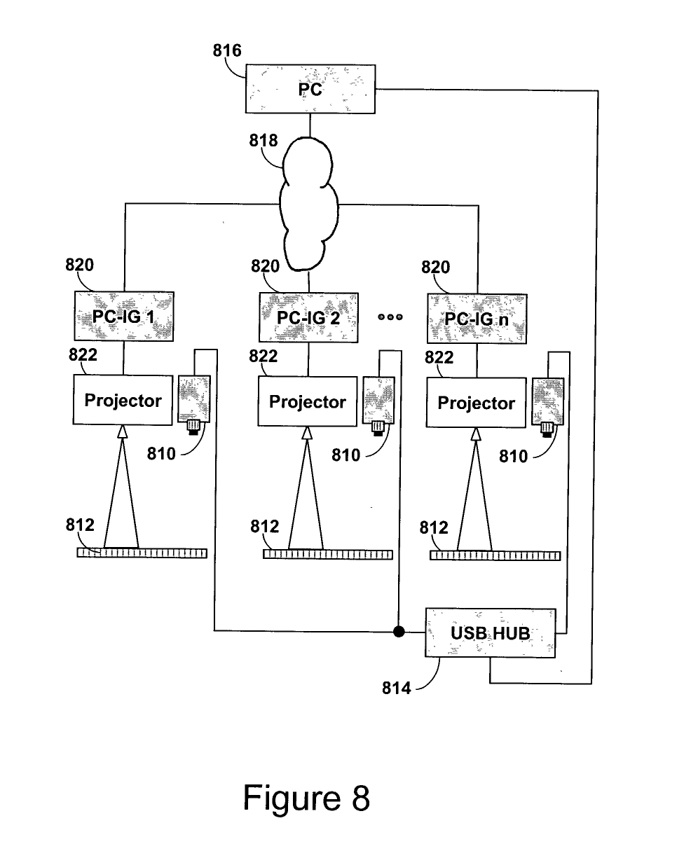

One aspect of the disclosed invention supports color matching in a similar manner to the Intensity Shadow Buffer described above. A near optimal gamma can be calculated for a given IG, graphic board, projector combination, etc. by applying a Gamma Shadow Buffer on a per pixel basis. Further, a particular color (i.e., red, blue, or green) can have gamma applied to its bit encoding. FIG. 8 provides an exemplary schematic block diagram illustrating the hardware configuration utilizing cameras 810. These cameras 810 are connected to a USB hub 814 that is networked to a PC 816. An Ethernet 818 connection supplies the communications between the PC 816 and an “n” number of IGs 820. Each IG 820 supplies video output to its associated projector 822 system. The video is then projected onto the associated screen surface 812.

The color matching process begins with aligning the digital cameras 810 are aligned to capture images projected onto the screen surface 812. The projectors 822 are calibrated as needed. The digital cameras 810 are consistently calibrated to prevent automatic brightness adjustments and saturation from the projected images. The PC 816 issues a command via the Ethernet 818 to all the IGs 820 for the display of a white image. The digital cameras 810 each provide an image as feedback to the PC 816. The PC 816 determines which PC-IG 820 produces the least brightest image. The brightness of each image is computed for “n” captured pixels using the following formula:

$$brightness = ( \frac{{\sum }_{i = 0}^{n} 0.24 {r}_{i} + 0.67 {g}_{i} + 0.08 {b}_{i}}{n} ) ,$$

where r,g,b represent red, blue, and green respectively. The least bright PC-IG 820 image is designated as the “reference image”. Once the reference image (e.g., reference IG) is determined, the PC 816 allocates an RGB texture map of a resolution equal to that obtained by the digital cameras 810. The PC 816 issues a command for the IGs 820 to display an image consisting of a single color channel (i.e., either red, blue, or green). The PC 816 captures a digital camera image of the reference and non-reference projected images. Then, the corresponding color or channel of the RGB texture map is computed with the following formula:

$$Texel ( x , y ) = ( \frac{referenceimage ( x , y )}{\text{non-referenceimage} ( x , y )} ) ,$$

where each Texel is clamped to the range of [0,1]. This process is repeated for each remaining color channel.

The computed texture map that resides in the PC 816 for the given non-reference image is compressed using run-length encoding and transmitted to the corresponding non-reference image generator via the network. The corresponding non-reference IG decompresses the texture map and uses it as a modulated texture in the final single pass multi-texturing step of its Shadow Buffer process. This color matching process is repeated for each additional non-reference IG. Upon establishing the color matching Shadow Buffers for each IG, the PC 816 issues a command to every IG to resume normal processing using its new modulation texture for its final image.

Shadow Buffer Set-Up and Initialization

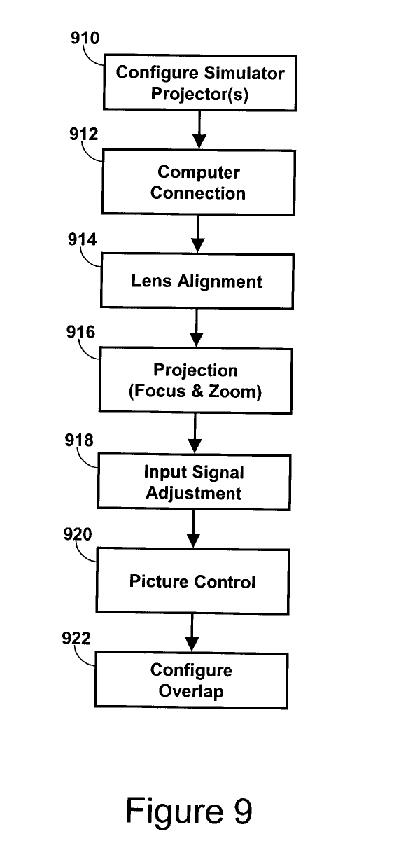

Continuing with the exemplary embodiment of the training simulator system 110 application, Shadow Buffer processing contributions are computed at initialization (e.g., memory retains data loaded upon initialization) and preferably cached thus, reducing real-time computation requirements. In order to support this type of processing, the Shadow Buffer settings are determined during system set-up. System set-up is user-controlled process that establishes system application settings prior to real-time operation of the system. Setup procedures are supported with computational means providing the user with a GUI and associated topical instructional support. For example, the Shadow Buffer software is accessed via a computerized control panel, which resides in computational system resources of the IG System 116. This control panel is comprised of step-by-step GUI guided support to obtain user controls, system inputs, and provide a means to setup desired data to be stored in the Shadow Buffer memories. The Shadow Buffer control panel aids the user in arranging projectors, distortion correction setup, establishing channel geometry, and creation of the desired edge blending. Additional user help is also supported via the user control panel. FIG. 9 depicts a high-level flow diagram of the processes supported by the Shadow Buffer control panel. Initially the projector geometry is established 910. This is comprised of the user supplying the following control panel inputs in relation to the projector placement being established:

Determine the quantity of projectors to be used in the configuration from one to n

Input the screen size desired

Locate the projector(s) at desired position(s) within a minimum and maximum horizontal distance between the projector lens and the screen

The computational systems (i.e., computers) are connected to the projector(s) 912. This includes video cables, audio cables, power cables, and interface/data connections (e.g., computer ports, mouse control connections). Testing to verify proper connections is supported via the control panel.

The user, via the control panel, accesses lens alignment 914 support. This aids in vertical and horizontal positioning of the projector's lens relative to the center of the screen area the projector is being configured to support. Once the projector lens is centered relative to the screen area, the control panel provides user support to determine the rotational orientation of the projector. The user follows step-by-step procedures to level the projector thus establishing projector lens alignment.

Projecting 916 supports step-by-step focus and zoom screen image adjustments. The user depresses the control panel button causing the projector to display a mesh pattern onto the projection screen in this preferred embodiment. The user then rotates the projector focus ring until the pattern on the screen is in focus. Upon establishing the projector focus, the user indicates this via the control panel (e.g., depresses the focus “ok” button on the control panel screen). The control panel displays instructions for the user to now establish the correct zoom adjustment of the projector system. The projector zoom ring is adjusted to be the size of the screen image. Again, the user indicates the zoom has been established via the control panel in the same manner as with the focus adjustment. This may be an iterative process of performing alternate focus and zoom adjustments until the proper projection has been established and acknowledged by the control panel via correct user inputs.

Input signal adjustment 918 permits the user to control the horizontal and vertical positions of the input signal for the selected projector. First the horizontal size is established. Then, the horizontal position of the screen image is adjusted from left to right. The vertical position adjustment controls the vertical position of the screen image up and down. The dot phase adjustment is made as the next step in this process. The dot phase adjusts the fineness of the screen image. Geometry adjusts the squareness of the screen image. Dynamic range is then adjusted for the green video by establishing the contrast, brightness, gain, and bias with either default values provided or user-controlled inputs. While determining these settings, the red and blue gain and bias are zeroed in essence turning these colors off. Upon calibrating the green settings, color balance is established for both red and blue video utilizing respective bias and gain controls.

Picture control 920 permits user-control for adjustment in the contrast, brightness, color temperature, and gamma correction of the projected image. The user views the screen image while making adjustments to each picture control. Default values are provided for contrast and brightness or the user may elect to adjust these settings. Color temperature refers to the white color of the image appearing blueish for a high setting in a range that varies to a low setting appearing reddish for the white color. Gamma correction is supported for adjustment of half tones.

Configure overlap 922 is performed as described above where the number of monitors and projector location is input into the system FIG. 6. The user establishes the edge-overlap and overlap intensity settings to complete the setup procedures.

Real-Time Shadow Buffer Processing

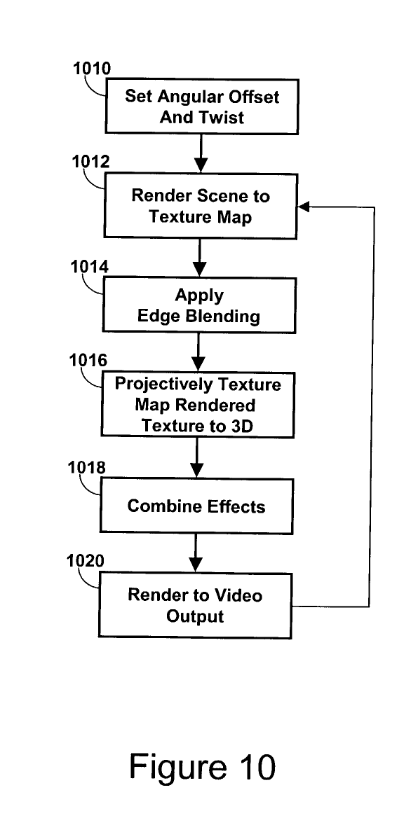

Another aspect of the invention disclosed is the Shadow Buffer processing during real-time, a high-level of which is illustrated in FIG. 10. This processing draws on software constructs in memory of an IG system or a graphics board frame buffer memory. Per pixel or per sub-pixel Shadow Buffer contributions are computed and/or loaded at initialization. Shadow Buffers are then “frozen” (e.g., memory retains data loaded upon initialization) and preferably cached thus, reducing real-time computation requirements. During initialization, the angular offset and twist data are loaded to support the video channel geometry 1010. A scene of imagery is rendered to a texture map at high resolution referencing the eye-point 1012. Edge blending is then applied to the rendered image by alpha blending a black textured rectangle of a width equal to the blend region. This one-dimensional texture is pre-computed using the following function:

$$α = 1.0 - {[ x / w ]}^{1 / γ}$$

where x ranges from 0-1, and represents the texture coordinates of the “black textured rectangle” across its width, w is equal to the width of the blend region in pixels, and γ is equal to the gamma value of the display system. Projectively texture map the rendered texture to a 3D representation of the display surface 1016. A curved display surface is modeled as an elliptic torus applying the following equations:

x(u, v)=(a+b cos(v)sin(u))

y(u, v)=c sin(v)

z(u, v)=−(a+b cos(v)co(u))

where a is equal to the distance from the center of the toroid to the center of the tube; b is equal to the horizontal tube radius, u,v are the horizontal and angular degrees along the torus. These parameters for a section of the width w and height h are computed using the following equations:

$$u = \pm [ a sin [ w / 2 ( a + b ) ] ]$$

$$v = \pm [ a sin [ h / 2 c ] ] .$$

Toroidal, ellipsoidal, and spherical surfaces may all be represented in this manner. The frequency at which the surface is sampled and tessellated is controllable by the user. Effects are then combined using single pass multi-texturing 1018, additive or modulated per-pixel effect may be combined. This permits real-time color filtering, blemish correction, and image intensification, etc. processing in real-time. Finally, the multi-textured section of the elliptic torus is rendered to the video output 1020 from the perspective of the projector lens relative to the display surface. This stage is rendered at the projector's native resolution and sub-pixel precision is achieved through bilinear filtering if the rendered texture is of higher resolution that the projector. Anisotropic filtering may also be utilized to correct for highly distorted surfaces. This process is repeated for each frame of imagery to be displayed in real-time.

Digital Video Combiner (DVC)

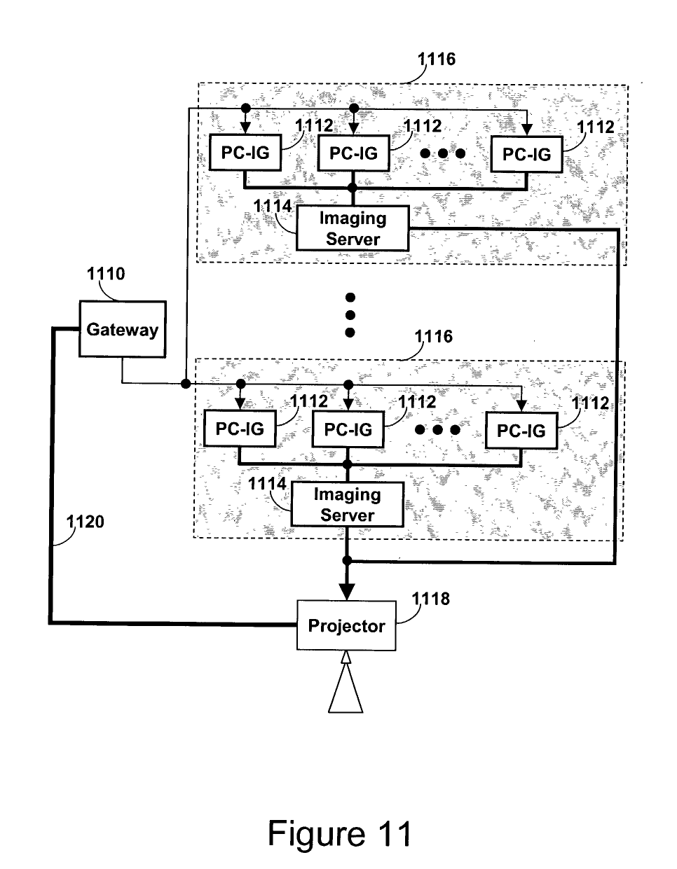

The parallel architecture inherent in the disclosed invention is leveraged by DVC processing where the image processing workload is distributed among a plurality of rendering units to produce ultra high-resolution (UHR) imagery while overcoming limitations encountered with COTS (commercial-off-the-shelf) hardware such as pixel fill limitations. Compared to IGs with similar capabilities, the DVC solution processes high-resolution imagery with increased visual complexity and full scene anti-aliasing (FSAA) at a fraction of the cost. FIG. 11 depicts an exemplary embodiment representing major components of a DVC configuration to achieve UHR where the gateway 1110 provides control data to the PC-IG(s) 1112 and receives sync data 1120 from the projector 1118 system. The gateway 1110 communicates with PC-IG(s) 1112 via high-speed, wide band communication (e.g., an Ethernet type communication bus link). A PC-IG 1112 may be a single board computer, a desktop personal computer, a motherboard populated with appropriate computing devices, or any other commercially available computing apparatus capable of generating video images. Image processing may be accomplished at a pixel (i.e., raster), and/or sub-pixel level. Upon completion of the rendering process, each PC-IG 1112 (i.e., rendering unit) digitally transmits its portion of the final scene to an imaging server 1114 (i.e., hyper-drive). This parallel architecture translates to each PC-IG 1112 processing FSM of only a portion of the final imagery scene. The imaging server 1114 digitally fuses tiles, stripes, or columns of each individual PC-IG 1112 scene portion into a final contiguous representation of the entire scene to be output to the projector 1118 system. Data types may comprise analog or digital standards (e.g., digitally encoded, direct digital, digital video interface (DVI), FireWire, etc.). In this exemplary embodiment, the imaging server 1114 comprises a PC-MUX board, which digitally combines video contributions from each PC-IG 1112 into a single scene or portion of the scene (dependent on the quantity of IG banks 1116 utilized). The projector 1118 system may comprise of at least one of any type of commercially available display or projection solution (e.g., monitors, flat panels, projectors, etc.). Once the imaging server 1114 combines the imagery comprising the scene, it is outputted to the projector 1118 system. The projector 1118 system then projects the combined imagery as a single anti-aliased, UHR scene.

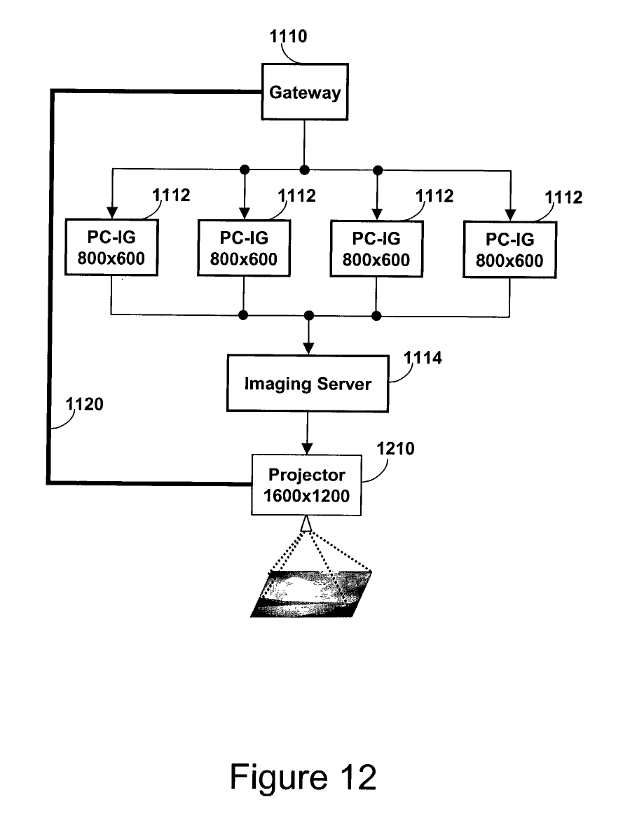

As depicted in FIG. 11, the gateway 1110 may support a single IG bank 1116 or multiple IG banks where an IG bank 1116 consists of a plurality of parallel PC-IGs 1112 output to a single imaging server 1114. The quantity of IG banks 1116 utilized is dependent of the projector 1118 system input requirements and the desired composite resolution. By way of example, consider the quad arrangement depicted in FIG. 12 that consists of four PC-IGs 1112, each contributing 800×600 resolution. Each PC-IGs 1112 (e.g., COTS graphics board) processes 800×600 FSAA with polygon and pixel-fill capabilities applied to one-fourth of the Field-Of-View (FOV). Upon the imaging server 1114 processing the scene, this single output yields an overall 1600×1200 FSAA, which is input to a single channel projector 1210. Conversely, if the projector 1118 system supported a plurality of inputs, a plurality of IG banks 1116 would be utilized, one for each projector 1118 system input. By way of example, consider a 20 Megapixel laser projector system with four inputs. In order to achieve the desired 5000×4000 resolution, four IG banks 1116 would be required. Each bank would possess four PC-IGs 1112 each contributing 1280×1024 resolution. This example may be furthered by considering a configuration where three 20 Megapixel laser projector systems as defined above are configured in an array to produce a panoramic scene, in essence tripling the architecture. It will be appreciated, that the exemplary configurations delineated are just examples of a DVC that would allow the use of the disclosed invention. It should be further appreciated that numerous other configurations and applications could be used depending on the requirements of any given application.

Thus, it will be appreciated that the Shadow Buffer system and method of the disclosed invention systematically and accurately yet inexpensively integrates all comprehensive aspects comprising of but not limited to composite video corrections and enhancements. These comprehensive capabilities minimize the costs associated to hardware for the visual display system and are integrated in a way that can be readily used by a large number of application types. Further, the parallel nature of the Shadow Buffer supports combinations for custom applications. For example, up to the memory limitations of a particular device, the Shadow Buffers can be utilized to soft-edge blend, digitally warp projected image tiles, and simultaneously correct for defects in the projector and screen. Additional combinations and other extensions are obvious to others familiar with the current state of the art.

While the preferred and exemplary embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A system for adjusting digitally generated images for single monitors, single projectors, and arrays of monitors and projectors of raster images to form composite blended images from multiple frame buffer inputs comprising:
a N dimensional array of Shadow Buffers, each Shadow Buffer being loaded with a pre-selected value associated with at least one of a sub-pixel, a pixel, and a region of each input memory to be blended into an entire composite image; and
means for applying the Shadow Buffer values to data corresponding to a digital image to effect modification of each of at least one of the sub-pixels, pixels, and regions to produce a non-distorted blended image.

2. The system of claim 1, wherein the applying means comprises means for blending or superimposing multiple digital images into a single blended image.

3. The system of claim 1, wherein the applying means comprises means for blending real-time video or sensor image digital data while simultaneously superimposing computer generated simulated visuals or sensor images into a single blended image, each source image of the resultant blended image being brightened or dimmed for emphasis or reduction of visible contribution.

4. The system of claim 3, wherein the applying means comprises means for surrounding the blended image with additional synthetic vision displays to increase situational awareness by increasing the apparent field-of-view (FOV).

5. A system for adjusting digitally generated images to compensate for projection artifacts and screen defects and/or blended images comprising:
at least one display device;
at least one image generation system for producing raster images;
a N dimensional array of Shadow Buffers, each Shadow Buffer being loaded with a pre-selected value associated with at least one of a sub-pixel, a pixel, and a region of each input memory to be blended into an entire composite image; and
means for applying the Shadow Buffer values to data corresponding to a digital image to effect modification of each of at least one of the sub-pixels, pixels, and regions to produce a non-distorted blended image.

6. The system of claim 5, wherein the applying means comprises means for soft edge blending of adjacent overlapping raster images.

7. The system of claim 5, wherein the applying means comprises means for matching color outputs of the raster images.

8. The system of claim 5, wherein the applying means comprises means for adjusting individual image intensity for multiple image blending.

9. The system of claim 8, wherein the applying means comprises means for correcting occurrences of horizontal, vertical, and geometric color purity shifts by adjusting the brightness of the composite image according to the Shadow Buffer values.

10. The system of claim 5, wherein the applying means comprises means for correcting occurrences of optical keystone and pin cushion effects by masking image edges and adjusting the color space contributions with spatial alterations for the remaining pixels of the raster images according to the Shadow Buffer values.

11. The system of claim 8, wherein the applying means comprises means for applying the Shadow Buffer values per sub-pixel or pixel to adjust selected portions of the composite image which are brighter to be diminished more strongly than selected portions of the composite image which are darker.

12. A system for adjusting video signals representing an array of raster images to compensate for projection defects and screen defects comprising:
a plurality of projectors for displaying an array of raster images forming a composite projected image, each raster image including image pixel values having red, green, and blue color components;
means for storing N dimensional array of Shadow Buffer values, each Shadow Buffer value being associated with at least one of a sub-pixel, a pixel, and a region projected image;
means for applying the Shadow Buffer values to data forming the raster image to remove projection and screen defects resulting from display of the array of raster images, wherein the Shadow Buffer values comprises:
an intensity Shadow Buffer array comprised of sub-pixel or pixel values that digitally adjusts the associated image pixel values by addition, subtraction, shifting, masking of bits, or colors, scaling, accumulation, logical and bit-wise operations;
a gamma Shadow Buffer array comprised of sub-pixel or pixel values that digitally adjusts the associated image pixel values by addition, subtraction, shifting, masking of bits, or colors, scaling, accumulation, logical and bit-wise operations;
a color space Shadow Buffer array comprised of sub-pixel or pixel values that digitally adjusts the associated image pixel values by addition, subtraction, shifting, masking of bits, or colors, scaling, accumulation, logical and bit-wise operations; and
a geometry correction Shadow Buffer array comprised of sub-pixel or pixel values that digitally adjusts the associated image pixel values via a Shadow Buffer edge mask coupled with a redistribution of the masked pixels values across the remaining displayed pixels.

13. The system of claim 12, further comprising a gamma correction means coupled to the multiple Shadow Buffers to adjust the gamma prior to projection of the raster images.

14. The system of claim 12, further comprising an intensity correction means coupled to the array of Shadow Buffers to adjust the intensity prior to projection of the raster image.

15. A method for color and intensity matching of images generated by a plurality of projectors comprising:
projecting a plurality of images from corresponding projectors in response to image data obtained from a plurality of image generation devices;
monitoring each projected image from each of a plurality of projectors to obtain color and intensity values for each image;
determining from the monitored color and intensity values from one of the corresponding projectors and its associated image generation device the lowest luminance value of color and intensity to establish a reference value; and
applying the reference value to each of the remaining image generation devices to adjust color and intensity to a uniform value for all projectors.

16. The method of claim 15, where the image intensity of each image is calculated for “n” captured pixels is calculated using the following formula:
$$Intensity = ( \frac{{\sum }_{i = 0}^{n} 0.24 {r}_{i} + 0.67 {g}_{i} + 0.08 {b}_{i}}{n} )$$
where r,g,b represent red, blue, and green respectively.

17. The method of claim 15, where the image color texture map is computed with the following formula:
$$Texel ( x , y ) = ( \frac{referenceimage ( x , y )}{notreferenceimage ( x , y )} )$$
where each Texel is clamped to the range of [0,1], x,y are special coordinates in the image color texture map.

18. The method of claim 15, that further includes edge blending of each projected image to form a seamless projected image comprised of selecting an area of overlap of adjacent images and reducing the intensity of at least one of the images at the area of overlap until at least one image at the area of overlap becomes non-discernable.

19. A method for obtaining improved quality of images generated by a plurality of projectors comprising processing a plurality of image data in the plurality of image generation devices at a higher resolution than the plurality images being projected from corresponding projectors.

20. A system for producing ultra high resolution of digitally generated images for single monitors, single projectors, and arrays of monitors and projectors of raster images to form composite blended images from a plurality of digital video combiner inputs comprising:
a N dimensional array of image generators, each image generator being associated with at least one portion of the entire composite image;
a means for digitally combining inputs from a plurality of image generators to form a contiguous composite image;
a means for applying the digital video combiner values to data corresponding to a digital image to effect modification of each of at least one of the sub-pixels, pixels, and regions to produce a non-distorted blended image; and
a means to display the resultant composite imagery.

21. The system of claim 20, wherein the applying means comprises means for blending or superimposing multiple high-resolution digital images into a single blended image collectively producing ultra high-resolution.
